(19) United States
(12) Patent Application Publication
(10) Pub. No.: US 2021/0038936 A1
(43) Pub. Date: Feb. 11, 2021

(54) Test Method and Test System for Testing a System for Monitoring the Protection Readiness of a Fire Protection Installation

(71) Applicants: Minimax Viking Research & Development GmbH, Bad Oldesloe (DE); VdS Schadenverhütung GmbH, Köln (DE)

(72) Inventors: Klaus HOFMANN, (DE); Joachim BÖKE, Düsseldorf (DE); Robert Reinemann, (DE); Kim-Kristin Prior, (DE)

(21) Appl. No.: 16/945,144

(22) Filed: Jul. 31, 2020

(30) Foreign Application Priority Data
Aug. 8, 2019 (EP) 19190740.1

(51) Int. Cl. A62C 37/50

(52) U.S. Cl. CPC A62C 37/50

(57) ABSTRACT

The invention relates to a test method for testing a system for automated monitoring of a protection readiness of a fire protection system. The test method comprises the following steps: Receiving at least one test parameter of the system, evaluating the at least one test parameter on the basis of at least one specification for the at least one test parameter, and determining, on the basis of the evaluation, a quality indicator indicating the quality of the system's monitoring of the fire protection system.

This application claims priority to European Patent Application No. 19190740.1 filed Aug. 8, 2019, the contents of which application is incorporated herein by reference in its entirety.

### TECHNICAL FIELD

The present invention relates to a test method and a test system for testing a system for monitoring the protection readiness of a fire protection system.

### BACKGROUND AND SUMMARY OF THE INVENTION

In this context, a fire protection system is any type of system that can be used for the purpose of (preventive) fire protection in buildings, halls, rooms or similar. Such fire protection systems may include, without limitation, fire alarm systems, fire extinguishing systems, spark extinguishing systems, smoke venting systems and/or a combination of these. Fire protection systems within the meaning of the invention are in particular systems which comprise a central device and one or more peripheral devices and/or components which are in communicative connection with the central device.

It is known that fire protection systems must comply with regulations which are described by corresponding specifications and/or guidelines. These specifications and/or guidelines require, among other things, regular inspections to monitor the protection readiness of fire protection systems. These regular inspections include in particular test runs of individual peripheral devices, such as sensors, pumps, alarm indicators, etc., conducted at regular intervals.

In accordance with these regulations, an operator is thus obliged, for example, to carry out the inspections specified in the guidelines by means of corresponding test runs on a weekly, monthly, quarterly and/or annual basis. The implementation of these inspections (and their corresponding documentation) in conformity with the guidelines is a duty of the operator without which the operational readiness of the fire protection system cannot be ensured.

According to the prior art, these inspections/test runs are mostly carried out and documented by hand, i.e. manually. In this respect, the time and money spent on each of these inspections is a major problem. This issue is particularly problematic if the fire protection system to be inspected is located in a remote area. In such cases, it may happen that, due to the great effort involved, the inspections/test runs are not carried out in accordance with the specifications and/or not in conformity with the guidelines—in particular not regularly at the intervals specified by the specifications and/or guidelines and/or to the extent specified by the specifications and/or guidelines—and that the results of the inspections/test runs are transmitted in a falsified form.

In the past, efforts have been made to automate these inspections in order to counter this problem. However, this kind of automation is associated with some difficulties. For example, during a test run of a pump or an alarm indicator it is necessary to transition the fire protection system to be monitored/tested from an operating state in which the fire protection system can perform a fire protection action, such as a fire extinguishing action, to a testing state in which the test run can be carried out.

In this situation there is a risk that a fire event will occur during the test run. In such a case, it must be ensured that the fire protection system can return from the testing state to the operating state at short notice in order to be able to fight the fire event efficiently. If the test run is carried out manually, the trained person can cancel the test run and thus change the fire protection system to the operating state. This is not possible if the test run is carried out automatically. The automation of the test runs thus requires that the immediate transition from the testing state to the operating state is also guaranteed in the case of a fire event.

In this context, DE 10 2018 119 776 discloses a water extinguishing system that is configured to carry out an automated pump test run. For this purpose, the water extinguishing system comprises a shut-off device in the test line used for the pump test run, which automatically closes the test line if the water extinguishing system is triggered, thus ensuring that the extinguishing fluid is fully available to the fluid supply of the water extinguishing system. In other embodiments, the automated pump test run may also be configured differently, for example, via a narrow bypass opening.

In the past, such efforts to automate the monitoring of fire protection systems failed because the requirements resulting from automation were not taken into account in the specifications and/or guidelines. However, since the functionality of fire protection systems is of great relevance for safety, no automatically monitored fire protection system could be considered to meet safety requirements without such definitions and requirements being provided by specifications and/or guidelines.

It is therefore desirable to provide a method, which also takes into account these requirements arising from the automation of test runs—for example, an automatic return from the testing state to the operating state—and which, in particular, defines and checks corresponding parameters and includes them in the quality indication. Accordingly, these further requirements must also be taken into account when testing a system for automated monitoring of the protection readiness of a fire protection system.

Furthermore, the automation of the monitoring of the protection readiness of fire protection systems allows individual system components to be arranged at different locations. For example, the evaluation unit for evaluating the test results of the test run may be located at a different location than the fire protection system, where the evaluation unit and the fire protection system can communicate with each other via a secure communication link. This allows a user, such as the operator of the fire protection system, to view the results of the test runs without having to go to the fire protection system itself, in particular its central device. This is particularly advantageous in the case of fire protection systems that are located in places that can only be accessed with difficulty or great effort.

However, if, as described above, the individual system components of the systems for automated monitoring of the protection readiness of the fire protection system are distributed across several locations, this further complicates the testing of the system, since the testing of the individual components may require travel to several locations. It is therefore advantageous if the testing can also be performed via remote access.

In this case, however, it should also be noted that remote access, for example, via a wired or wireless communication link, is associated with certain security risks. In particular, it may be possible in such a case to access, modify and/or insert and/or delete information transmitted via the communication link during transmission. This can be particularly problematic for high-security information—as in the present case of fire protection systems. Thus, when remotely testing a system for the automated monitoring of the protection readiness of a fire protection system, measures must also be taken to prevent such incidents.

Against this background, the present invention undertakes to provide a test method and test system for testing a system for monitoring the protection readiness of a fire protection system, where such test method and test system do not have the disadvantages mentioned above. In particular, it is an object of the present invention to provide a test method and a test system by means of which an inspection of a fire protection system by a system for the automated monitoring of the protection readiness of the fire protection system can be ensured, the inspection being in conformity with the specifications and in particular in conformity with the guidelines. Specifically, it is an object of the invention to provide a test method and a test system with which, on the one hand, it is possible to prevent the transmitted data from being altered, falsified, deleted and/or inserted, and with which, on the other hand, a test of the system can be carried out both via local access on site and via remote access, preferably in automated manner.

This object is achieved, according to the invention, by means of a test method for testing a system for monitoring the protection readiness of a fire protection system, the test method comprising the following steps: receiving at least one test parameter of the system, evaluating the at least one test parameter on the basis of at least one specification for the at least one test parameter, and determining, on the basis of the evaluation, a quality indicator indicating the quality of the system's monitoring of the protection readiness of the fire protection system.

Thus, according to the invention, a test method is provided which makes it possible to test a system for the automated monitoring of the protection readiness of a fire protection system. This is done by evaluating at least one test parameter on the basis of a specification—from a guideline, for example—for such test parameter. On the basis of the evaluation, a quality indicator may be determined which indicates the quality of the system's monitoring of the protection readiness of the fire protection system.

In this respect, a system for the automated monitoring of the protection readiness of a fire protection system is understood to refer to any system that allows automated inspections/test runs of the fire protection system, in particular of the peripheral devices, such as sensors, pumps, alarm indicators or similar therein, to be carried out, in order to determine to which extent the protection readiness still exists.

In this context, the protection readiness of the fire protection system is particularly to be understood as a proper functionality of the fire protection system. The protection readiness comprises in particular the operational readiness of the fire protection system, i.e. the functionality of being able—in the event of a fire—to transition from an operational readiness state to an operating state in which a fire fighting action is initiated. This means that in the event of operational readiness it is ensured that all components of the fire protection system are in a functionality-guaranteeing condition. This comprises in particular terminating test runs, shutting off test circuits, opening a fluid supply of an extinguishing system, automatically starting pumps for fluid supply and similar.

Alternatively or additionally, the protection readiness of the fire protection system may also be understood as the effectiveness of the fire protection system. In this context, the term effectiveness means that it is ensured that the fire protection system is able to fulfill the purpose assigned to it. For example, effectiveness of the fire protection system means that in the case of a fire event enough extinguishing fluid can be discharged to carry out the planned firefighting action, such as controlling the fire event and/or containing and/or extinguishing the fire event.

In some cases, the fire protection system may be ready for operation in principle, but have insufficient effectiveness due to certain operating parameters deviating from a nominal value. These operating parameters in particular may relate to the pump pressure and/or incrustation of pipes. Both would result in an insufficient fluid supply to the fire protection system and thus in an insufficient extinguishing functionality. Thus, this effectiveness preferably may also be tested as part of the protection readiness.

Alternatively or in addition, the protection readiness may also include aspects of organizational fire protection. Organizational fire protection includes, in particular, those aspects that relate to conditions that must not be changed beyond certain limits or benchmark values in order to ensure the functionality of the fire protection system. These points relate in particular to the fire load remaining to be fought by the fire protection system, which is characterized in particular by aspects such as materials within the fire protection area, storage height of the materials within the fire protection area, adequate distribution of extinguishing fluid, fire resistance duration and the like. Other factors in particular may pertain to proper maintenance and/or regular servicing of the fire protection system. Thus, it is checked whether the fire protection system fulfils all the prerequisites for being able to fight possible fire events, taking into account the framework conditions applicable to the fire protection area it monitors.

According to the invention, the test method comprises receiving at least one system test parameter for automated monitoring of protection readiness. Receiving at least one test parameter in particular means the receiving of this at least one test parameter by a receiver. In some embodiments the receiver is a user who then manually transmits the at least one test parameter for evaluation. In some embodiments the receiver is a receiving device that receives the test parameter and, without user interaction, passes it on to a processor unit for evaluation.

In this context, the term test parameter in particular means all parameters that allow a determination as to whether the system monitors the protection readiness of the fire protection system, i.e. in particular its operational readiness, effectiveness and organizational fire protection. The term test parameter thus includes both the parameters that describe certain properties of the system for automated monitoring, such as an indication that the system is configured to ensure the procedurally safe, i.e. operational, state of the fire protection system in the event of a power failure, and/or an indication that the system is configured to transition the fire protection system from a testing state to an operating state in the case of a fire event, for example, during a test run.

The test parameters may further comprise parameters describing the properties of the fire protection system, in particular parameters indicating the effectiveness of the fire protection system. In particular, the test parameters may comprise information on the amount of extinguishing fluid that can be discharged by the fire protection system in the event of fire for the purpose of containing and/or controlling and/or extinguishing the fire.

The test parameters may also include parameters indicating organizational fire protection. The test parameters in particular may comprise parameters that indicate whether certain conditions are within the range of specified benchmark values and/or measures. The test parameters may also comprise parameters indicating compliance with maintenance intervals and/or the quality and/or completeness of their documentation.

The test parameters may also relate to design aspects which may also be specified by specifications, in particular guidelines, such as the stability of the components used in the system, the design of the individual components, such as labeling and/or shielding of conduits, and the like.

The term test parameter further includes safety-relevant parameters of the system, such as an indication that the communication link or data transmission between the monitoring system and/or the operator of the fire protection system and/or a tester performing the test method is secured, for example, by a security key, where the security key may be configured in particular to be temporally changeable. In particular, this indication may indicate that the data transmission is preceded by an authentication and/or that the safeguarding of the communication link prevents that the data transmitted through it can be manipulated.

Alternatively or in addition, the test parameters may comprise an indication that the communication link between the system and the fire protection system is monitored to ensure that any non-availability of the communication link is immediately identified. In particular, this non-availability may refer to a non-availability for a certain maximum time (e.g. >20 s). In some embodiments the indication in particular specifies the manner of the monitoring of the communication link. In some embodiments this method may comprise in particular “pinging” the communication link at regular (predefined) intervals to determine whether it is still working properly.

Alternatively or in addition, the test parameters may also comprise parameters indicating the measurands to be monitored. This allows for checking whether the system for automated monitoring carries out the monitoring on the basis of the applicable measurands, i.e. whether the monitoring is carried out according to the specifications.

The test parameters may also relate to the recording and/or documentation of the monitoring system, which describe the condition of the fire protection system and/or individual peripheral devices therein, particularly the results of the individual test runs and the time intervals between the test runs. Other test parameters may also comprise a verification of the data, i.e. an indication that the data is being checked to prevent the data from being modified.

The test method further comprises an evaluation of the at least one test parameter. The evaluation of the test parameter is based on a specification which can be taken from one or more guidelines, i.e. a guideline specification. The guideline specification may be system-specific, i.e. specific to a certain fire protection system or a certain type of fire protection system, or it may be generally valid for all fire protection systems. The evaluation is preferably done by comparing the specifications, in particular those for the test parameters, with the test parameters transmitted by the system.

The evaluation makes it possible to determine in particular the quality of the automatic monitoring of the protection readiness of the fire protection system. The quality determined in this manner may be indicated in particular by means of a corresponding quality indicator. Preferably, the quality indicator is determined based on a series of related test parameters. The quality indicator thus makes it possible to determine, on the basis of the various test parameters, whether—and if so, to what extent—the system for automated monitoring of protection readiness is capable of monitoring the protection readiness in conformity with the guideline.

In a preferred embodiment, the at least one test parameter comprises a functional readiness indication, where the evaluation comprises determining, based on the functional readiness indication, that the system is configured to change the fire protection system from a testing state to an operating state in the event of a fire.

It is preferred that the test parameter comprises at least one indication that the system is configured to transition from a testing state to an operating state in the case of a fire event. In the context of the invention, this indication is also referred to as functional readiness indication.

In this context, a testing state may particularly correspond to a state to which the fire protection system is changed in order to carry out a test run, i.e. an inspection of a certain functionality of the fire protection system. As an example of such a test run, a pump test run should be mentioned, which is used to test the pump for the fluid supply of the fire protection system. For example, the regulations described in VdS 2212, para. 1.3.4 stipulate that such a pump test run must be carried out weekly. For this purpose, a test line is first released by opening a corresponding opening element. This test line is usually a water measuring device comprising a flow meter, stilling pipes, and regulating valves for testing the water rate and is preferably provided as a branch off of the distribution pipe downstream of the pump, the distribution pipe being used to supply a pipe network. Following the release of the test line, a starting device is used to trigger a pump start of the pump. This start may be automatic or performed manually. The starting pressure, which is the pressure at the time the pump is started, is then measured and recorded and the test run is carried out until the normal operating parameters of the pump drive motor are reached. The test line is then closed again by means of the opening element and no further extinguishing fluid can enter the test line.

If such a pump test run is to be carried out automatically, the system for automated monitoring requires a device that ensures that, in the case of a fire event, the pump test run—or any other test run—is terminated and the fire protection system transitions to the operating state. The operating state is the state in which the fire protection system is in operation, i.e. is used to initiate a fire protection action. The functional readiness indication now indicates that the fire protection system comprises such a device.

To check this, the evaluation of the test parameter preferably comprises an evaluation of the functional readiness indication. On the basis of this evaluation it can be determined whether the system is configured to change the fire protection system in the event of fire to a state in which it is ready for operation, i.e. ready to initiate the desired fire protection action. If the evaluation of the functional readiness indication shows that the fire protection system is not (no longer) capable of ensuring a return from the testing state to the operating state, it can be determined that the system no longer operates in accordance with the specifications, in particular the guideline specifications.

In a further embodiment, the test method also comprises determining, on the basis of the functional readiness indication, that the changing to the operating state takes place within a time span t, which is less than a predetermined threshold value, after a fire event has been registered.

The evaluation of the test parameter comprising the functional readiness indication preferably comprises determining the time period which the system—or the fire protection system monitored by it—requires to change the fire protection system to the operating state following the detection of an event of fire. Here, an upper threshold value may be specified for the time period—preferably on the basis of guideline specifications—indicating the maximum period of time the changing of the fire protection system to the operating state may take. In some embodiments this time period is in particular a time period t<60 s, preferably t<45 s, even more preferably t<30 s, even more preferably t<15 s. In some embodiments the time period is even shorter, in particular it may be required that the system is configured to initiate the transition from the testing state to the operating state immediately, i.e. as fast as possible.

If the specified time period is exceeded, i.e. the system needs more time than the specified time period to change the fire protection system to the operating state, it may be determined in this case as well that the system no longer operates in accordance with the specifications, in particular the guideline specifications. This means that, although the system in principle is able to change the fire protection system from the testing state to the operating state, this change does not occur fast enough and is thus insufficient to support the assumption that the system is working in conformity with the specifications.

In some embodiments the at least one test parameter further comprises a safety indication, where the evaluation comprises determining, based on the safety indication, that the system is configured to change the fire protection system from a testing state to an operational readiness state in the event of a power failure.

In the context of the invention, an operational readiness state is understood as corresponding to a state in which the fire protection system is ready for operation but no fire protection action is performed. Thus, the operational readiness state must be distinguished from the operating state insofar as the operational readiness state is a state which ensures that the fire protection system can change to the operating state in an event of fire.

As already mentioned previously, a fire protection system must remain operational even in the event of a power failure. This operational readiness must be ensured while the fire protection system is in the operational readiness state and not in the testing state, but also in cases where—at the time of the power failure—the fire protection system is being tested by the system for automated monitoring, i.e. while the fire protection system is in the testing state. The test method according to the invention checks this aspect as well.

For this purpose, the test parameter preferably comprises a safety indication indicating whether the system for automated monitoring is configured to change the fire protection system from the testing state to the operational readiness state, i.e. to operational readiness, if a loss of primary energy occurs during a test run. In this context, the test parameter comprising the safety indication is evaluated to determine whether the corresponding functionality of the system is (still) available. If the evaluation shows that this is not the case, it may thus be determined as well that the system no longer operates in accordance with the specifications, in particular the guideline specifications.

In some embodiments the at least one test parameter comprises a termination indication, where the evaluation comprises determining, based on the termination indication, that the system is configured to change the fire protection system from a testing state to an operational readiness state in the event of a test failure.

It may occur that the test run is not carried out as planned. For example, it may occur that during the test run, which requires a test line, this test line is not opened because, for example, the opening device has not been activated. Alternatively or additionally, if a test run is carried out through a bypass that is very narrow, this bypass may be blocked. In any case, such a malfunction during the test run would result in the pressure and/or flow of the fluid being too low to perform a (conclusive) test run. In order to prevent such a faulty test run from being carried out, the system should be configured to terminate the test run in such a case and to transition the fire protection system from the testing state to the operational readiness state.

For this purpose, the system preferably comprises a feedback function that provides positive or negative feedback regarding the test run. In the event of negative feedback, the system is then configured to terminate the test run and return to the operational readiness state. Alternatively or in addition, the system should be configured such that if a faulty test run is detected in the event of a fire, the system does not transition to the operational readiness state but instead to the operating state. In some embodiments the transition from the testing state to the operating state is made via the operational readiness state. In some embodiments the fire protection system directly changes from the testing state to the operating state in such a case.

The test method provides for testing this functionality as well. For this, the system creates a termination indication and passes it on for checking. The method then comprises a determination, based on the termination indication, whether this functionality is available in the system and still functions properly.

In some preferred embodiments, the at least one test parameter comprises an evaluation result of an evaluation of at least one measured value of at least one measurement parameter indicative of the protection readiness of the fire protection system. The evaluation of the at least one test parameter further comprises a determination of all measurands to be tested and a comparison whether the at least one test parameter comprises at least one evaluation result for each measurement parameter to be tested.

In some embodiments the at least one test parameter may also be indicative of a recording—or documentation—of the automated monitoring of the protection readiness. In particular, the test parameter may indicate whether all measurands specified as to be tested by specifications, in particular guidelines, have actually been tested. For this purpose, the test parameter preferably comprises an evaluation result of an evaluation of the measurands to be tested, where the evaluation is carried out by the system for automated monitoring.

In one embodiment the evaluation of the at least one test parameter comprises an evaluation of the evaluation result as transmitted by the system for automated monitoring. Here, the evaluation of the evaluation result comprises in particular determining for which measurement parameter a test run was carried out and a corresponding evaluation was performed. The test method checks the technical data of the measurement parameter, i.e. it checks whether the correct physical input variable was transmitted, whether its input range was correct, whether the physical output variable was determined correctly and whether its output range was correct, whether the mathematical relationships between input and output variables, the tolerances used and/or the response times for the individual measurement parameters comply with the specifications, and similar. This makes it possible to determine whether all measurement parameters to be tested have actually been tested by the system for automated monitoring and whether the corresponding test runs have been carried out within the scope of the specifications. Thus, it is checked whether the system for automated monitoring has carried out the test runs in such a way that all values determined during the test runs guarantee a statement about the protection readiness of the fire protection system. In particular, it may be checked whether the system for automated monitoring has carried out the test runs in accordance with all specifications, in particular all guidelines. If it is determined in this case that one or more of the measurands to be tested have not been tested and/or evaluated, or have not been tested and/or evaluated correctly, it can be assumed that no test runs were carried out that are conclusive and/or in conformity with the specifications.

Furthermore, by evaluating the evaluation result, it can be determined whether the fire protection system tested by the system for automated monitoring has all the functionalities guaranteeing the protection readiness. These functionalities can be defined in particular by corresponding specifications, particularly by corresponding guidelines. Thus, by evaluating the evaluation result, it is determined whether the fire protection system tested by the system for automated monitoring still functions in conformity with the specifications and/or whether a peripheral device and/or a component of the fire protection system has a functionality that deviates from the specifications. This may in particular relate to safety-relevant aspects, such as communication between the fire protection system and the system for automated monitoring. If it is determined at this point, for example, that the communication between the fire protection system and the system is no longer maintained safely, it can be determined that the system is no longer operating reliably.

In some embodiments the test method also comprises providing safeguarding of the at least one test parameter against modification by a user.

In order to ensure reliable operation of the fire protection system in the event of a fire, the system for automated monitoring must perform all specified test runs reliably and in conformity with the specifications. This performance must be recorded and documented in such a way that it is traceable if, when and how which test runs were performed. It is very important that the recording/documentation is not modified afterwards, i.e. that the evaluation results indicative for the test runs cannot be changed, for example, manually by a user. In particular, this user may be an unauthorized person who can access the evaluation results from outside and thus falsify them.

This problem is further aggravated if the test method is performed via remote access to the system and the evaluation result is transmitted via a communication link. On the one hand, such communication links are vulnerable to external unauthorized access and, on the other hand, they can be subject to interference, which can lead to incomplete or incorrect transmission of data.

It is thus preferable to provide that the test method also comprises safeguarding of the at least one test parameter against subsequent adjustment/modification, for example, by a user or by interferences during the transmission and/or the determination of the test parameter.

This safeguarding in particular may be in the form of a time stamp. For this purpose, the test parameter received is provided with a time stamp indicating when the test parameter was modified/created. This means that when the test parameter is created, a time stamp is generated that indicates the time at which the test parameter was created. If the test parameter is subsequently modified, the time stamp also changes, thus making it possible to determine that a modification was made.

In some embodiments the safeguarding may alternatively or in addition comprise an encryption of the test parameter. The test parameter is thus encrypted by the system and received in encrypted form. In this case, the evaluation of the test parameter comprises an initial decoding of the test parameter. This ensures that the test parameter cannot be modified during transmission. Furthermore, the use of encryption may also be used to uniquely identify the system to be tested when the test method is performed.

In some embodiments the at least one test parameter comprises an identification of at least one component of a system for automated monitoring of the fire protection system. Here, the evaluation comprises a check of an approval of the at least one component of a system for automated monitoring of the fire protection system on the basis of the identification.

It may be necessary to verify the use of certain components in the system for automated monitoring, in particular the use of components which have been tested and found suitable for use in fire protection. These components may include in particular certified components. In this case, the test method may also be used to check whether the specified components are actually used, and only in that case to consider the system as reliable and/or compliant with the specifications.

For this purpose, the test parameter preferably comprises an identification of the at least one component. This identification may be carried out in particular with the use of an identification number that uniquely identifies the component. In some embodiments the identification may also comprise a type identification, which identifies the component type rather than the component itself. In some embodiments the identification may also include a check of the component, thus making it possible to determine as part of the identification whether the component is functioning according to all specifications.

Here, the evaluation of the test parameter comprises a check of the approval of the at least one component. This is preferably done by comparing the identification of the component with a list of components and/or component types which have been tested and/or are suitable for fire protection and therefore approved, in particular certified components and/or component types. This list is preferably generated on the basis of corresponding specifications and stored in a memory before the start of the test process. During evaluation, the list is then read out of the memory and the comparison is carried out. The specifications on the basis of which the list is generated may comprise general specifications valid for all fire protection systems or system-specific specifications defined for the corresponding fire protection system—or type of fire protection system—monitored by the system for automated monitoring.

In some embodiments the identification of the component may also be carried out using a chip, in particular an RFID chip. In this case a user can identify the components directly by reading the (RFID) chip. Alternatively or additionally, the components can be configured to identify themselves by means of the (RFID) chip, i.e. to transmit their identification, for example, by means of RFID [to the] test system and/or the system for automated monitoring of the fire protection system. Such identification by means of an RFID chip is known from WO 2019/012154 A1, for example.

In some preferred embodiments the specification is at least also identified by a guideline.

In order to ensure that all fire protection systems are monitored as equally as possible in terms of their protection readiness, the specifications for the system for automated monitoring may be defined in particular by corresponding guidelines, which must be observed by all operators using a system for automated monitoring. This may ensure a high level of conformity. In particular, this makes it possible to compare the protection readiness of different fire protection systems of different operators in a manner that is as neutral as possible.

In a preferred embodiment the test method further comprises a check of at least one test history, where the test history indicates the progression of the test parameter over time.

In some embodiments the test method further comprises a checking of a test history. A test history may particularly be understood as corresponding to a record of the test parameters received by the system for automated monitoring as a function of time. Preferably, the test history is stored in a correspondingly provided memory of the test system.

The test history thus shows the progression of the test parameter over time. This progression over time makes it possible to trace whether the test parameters were received at the intervals specified—for example, intervals specified by the guidelines—and stored accordingly. In particular, the inspection history makes it possible to determine if an inspection parameter has not been received or stored correctly or at all.

It is preferable that the test method further comprises determining a time interval for the system to monitor the protection readiness of the fire protection system on the basis of the quality indicator. In some embodiments determining the time interval comprises determining the time interval that corresponds to at least one specification and/or guideline.

The automated monitoring of the protection readiness by the system is preferably carried out at predefined time intervals. These time intervals are usually specified by specifications and/or guidelines. For example, guidelines may specify that certain components or peripheral devices must be checked weekly, monthly, quarterly or annually, etc. The system for automated monitoring is configured to carry out the corresponding test runs at least in these time intervals. In addition, however, the system for automated monitoring may also carry out the test runs more often than specified by the time intervals.

However, it may happen that the quality indicator indicates that the quality of the automated monitoring is decreasing. This can be caused, on the one hand, by malfunctions and/or quality losses of the fire protection system being monitored and, on the other hand, by malfunctions and/or quality losses of the components of the system for automated monitoring. In both cases, it may be indicated to shorten the time intervals of the test runs, i.e. to carry out the test runs more frequently than required by the guidelines. In order to induce the system for automated monitoring to adjust the time intervals accordingly in such a case, the test method according to the invention further comprises an evaluation of the quality indicator and a corresponding determination of a new, adjusted time interval. This adjusted time interval, as well, is preferably indicated by corresponding specifications and/or guidelines.

This adjusted time interval is then transmitted to the system for automated monitoring, such system being configured to adjust the automated monitoring of the protection readiness accordingly, in particular the time intervals specified for the test runs.

In a further aspect the invention relates to a computer program having program code means which cause a processor unit to carry out the test method described above.

In a still further aspect the invention relates to a test system for testing a system for automated monitoring of a protection readiness of a fire protection system, the test system comprising: a receiving device which is configured to receive at least one test parameter of the system via a communication link, and a processor unit which is configured to evaluate the at least one test parameter on the basis of at least one specification for the at least one test parameter and to determine a quality indicator indicating the quality of the monitoring of the fire protection system by the system on the basis of the evaluation. In some embodiments the at least one test parameter includes a functional readiness indication, which indicates a system configuration to change the fire protection system from a testing state to an operating state in the event of a fire. Alternatively or additionally, the at least one test parameter comprises a safety indication which indicates a system configuration to change the fire protection system from a testing state to an operational readiness state in case of a power failure.

In some embodiments of the test system the communication link comprises a secured connection, in particular an encrypted connection. In some embodiments the communication link comprises a wireless communication link.

In a further aspect the invention relates to a test system which can communicate with the system for automated monitoring via a secure communication link. This secure communication link may be a wireless connection or cable connection. Preferably, the secured communication link is a wireless connection via a radio network, preferably the private radio network of an operator. In some embodiments the radio network may also be a mobile radio network.

The safeguarding of the communication link is preferably done by encryption. To this end, both the system for automated monitoring and the test system comprise a cryptographic device which allows the information transmitted to be encrypted and the information received to be decrypted. This ensures that the test is not falsified by an external user.

The communication link may also have error detection and/or error correction means. Such error detection and/or error correction means make it possible to detect any errors in the transmission of data, in particular the transmission of test parameters from the system for automated monitoring to the test system, and thus to initiate an error correction, for example, by requesting to resend the transmitted data. This makes it possible to carry out the test method with even greater reliability.

The test system according to the invention adopts the advantages and embodiments of the test method according to the invention, which is why reference is made to the above explanations regarding these advantages and embodiments.

### BRIEF DESCRIPTION OF THE DRAWINGS

The invention is described in more detail below with reference to the attached figures and using preferred embodiment examples. The figures show:

FIG. 1 a schematic representation of a system architecture according to the invention in a first embodiment, and

FIG. 2 a schematic flow chart of a test method for testing a system for the automated monitoring of a protection readiness of a fire protection system.

### MODE(S) FOR CARRYING OUT THE INVENTION

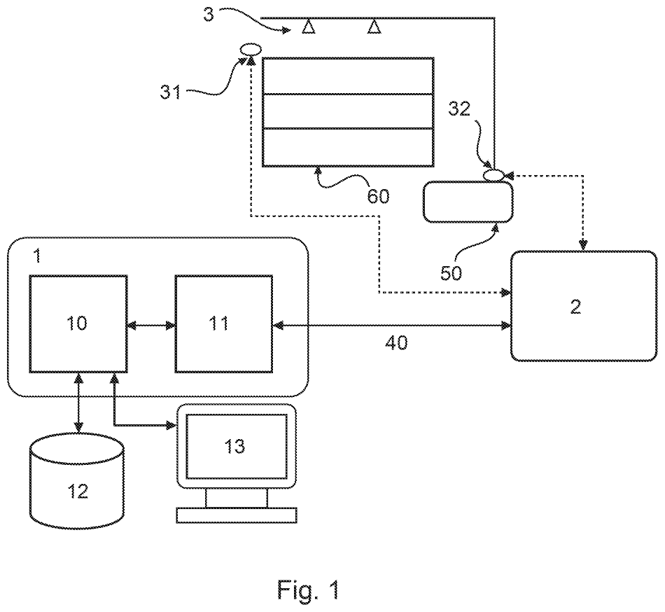

FIG. 1 shows a system architecture comprising a test system 1, a system 2 for the automated monitoring of a protection readiness of a fire protection system 3 and a corresponding fire protection system 3.

The test system 1 comprises a processor unit 10 and a receiving device 11 and is also communicatively connected to a memory 12 and a display unit 13. In some embodiments the memory 12 and the display unit 13 may also be designed as parts of the test system 1.

The receiving device 11 is configured to communicate via a communication link 40 with a system 2 for the automated monitoring of a fire protection system 3, which is shown as a black box in FIG. 1. In the embodiment of FIG. 1 the communication link 40 is an encrypted communication link. This means that the test parameters transmitted via the communication link 40 are encrypted by the system 2 and decrypted by the test system 1. For this purpose, the test system 1 and the system 2 each preferably comprise a cryptographic device (not shown), which is designed as part of the receiving device 11 in the embodiment of FIG. 1.

The system 2 is also configured to communicate with a fire protection system 3. The fire protection system 3 comprises a first sensor 31, a second sensor 32 and a peripheral device 50, which is designed as a pump in the specific embodiment of FIG. 1. In the embodiment of FIG. 1 the fire protection system 3 is used for fire protection of a fire protection area comprising the high rack 60.

The system 2 is especially configured to communicate with the first sensor 31 and the second sensor 32 of the fire protection system via corresponding communication links. The first sensor 31 and the second sensor 32 are used for the acquisition of measurement parameters during a test run of the fire protection system 3 and/or of a peripheral device 50 contained therein. Therefore, it is preferable to arrange corresponding sensors 31, 32 on each peripheral device that must be tested regularly.

Based on the determination of the measurands during the test runs, the system 2 can automatically monitor the protection readiness of the fire protection system 3. However, to ensure that the system 2 is operating in conformity with the specifications, this system 2 must be tested by the test system 1.

The test by the test system 1 is preferably carried out at the time the system 2 is installed and can thus represent a one-time, initial certification. In addition, the test can also be repeated at regular intervals, for example, to verify the certification after a specified time.

In the specific embodiment of FIG. 1, the test system 1 performs an initial certification. For this purpose, the receiving device 11 of the test system 1 receives at least one time-stamped test parameter from the system 2. In the specific embodiment of FIG. 1, this test parameter comprises a functional readiness indication, which indicates that the system 2 is configured to change the fire protection system 3 from a testing state to an operating state in the event of a fire. Furthermore, the test parameter comprises a safety indication indicating that the system 2 is configured to change the fire protection system 3 from a testing state to an operational readiness state in case of a power failure. The test parameter according to the specific embodiment of FIG. 1 further includes a benchmark value indication indicating that the requirements of organizational fire protection applicable to the fire protection system are fulfilled. This benchmark value indication indicates in particular that the storage heights of the materials within the fire protection area specified for the fire protection system are below the specified limit values and that the fire protection system 3 can guarantee an adequate distribution of extinguishing fluid in the fire protection area. The test parameter is transmitted in encrypted form via the communication link 40. The receiving device 11 is configured to decode the test parameter.

In the specific embodiment of FIG. 1 the communication link 40 is provided in particular by a correspondingly certified data transmission device. The certified data transmission device and the receiving device 11 preferably further comprise appropriate access restriction devices, which, for example, require the entry of a password and/or have an appropriate firewall.

Subsequently, the receiving device 11 passes on the decoded test parameter to the processor unit 10. The processor unit 10 is configured to evaluate the test parameter. For this purpose, the processor unit 10 first checks the time stamp of the test parameter to determine whether it might have been modified.

If no change is detected, the processor unit 10 further determines, on the basis of the functional readiness indication, whether, in the event of a fire, the system 2 is configured to change the fire protection system 3 within a period of less than 30 seconds from a testing state in which a test run is performed to an operating state which allows a fire protection action, such as an extinguishing action, to be performed. Although in the example of FIG. 1 the change is to be carried out in less than 30 seconds, it should be understood in this respect that other time periods are also possible, where the time periods can be determined depending on a specification which is either generally applicable or specific to the fire protection system.

During the evaluation, the processor unit 10 further determines on the basis of the safety indication whether the system 2 is configured to change, in case of a loss of primary energy during a test run, the fire protection system 3 from a testing state to an operational readiness state in which the fire protection system 3 is ready for operation, i.e. in which it can switch to the operating state.

Furthermore, the processor unit 10 determines, during the evaluation on the basis of the benchmark value indication, that the storage heights of the materials within the fire protection area specified for the fire protection system 3 are below the specified limit values and that the extinguishing fluid supply by the fire protection system 3 within the fire protection area meets the necessary requirements.

If the evaluation by the processor unit 10 shows that the system 2—in the case of a test run—can guarantee both a changing to the operating state and to the operational readiness state, depending on the corresponding event, and that the necessary frame-work conditions of organizational fire protection are complied with, the processor unit generates a corresponding certification indication and outputs it to the display unit 13. The display unit 13 generates a graphical representation of the certification indication and outputs it to a user. The user is thus notified that the system 2 can be certified. The user can then issue the certification. In some embodiments the certification may also be issued automatically via the communication link 40.

The certification obtained in this manner may then either be permanent or limited to a certain, fixed time period. During this time period, regular checks are preferably carried out to compare the quality of the components used with the fire protection system 3 initially tested. This quality can be indicated by the quality indication. If the quality indication meets a predefined minimum value, the certification can be extended after the specified period of time. However, if the quality indication indicates that the quality is no longer guaranteed, an extension of the certification can be refused. The quality indication can be determined in particular on the basis of the test parameters and—optionally—on the basis of external information (for example, from the product market).

The processor unit 10 is further configured to write the received test parameter into the memory 12. If the test system 1 is then used to regularly carry out tests of the system 2, the individual test parameters received can be stored in the memory 12 as a test history in order to be able to trace their progression over time. This in particular makes it possible to determine the time intervals between the tests and can also serve to verify that the tests have been carried out regularly and correctly.

Although in the specific embodiment of FIG. 1 the test of a pump 50 was described as an exemplary embodiment of an automated test run, the test system may, alternatively or additionally, test specifications of other automated test runs. Another example is an alarm test. In the case of an alarm test, the optical and acoustic alarming is automatically checked. Here, again, it must be guaranteed that the test run is terminated in case of fire and that the fire protection system 3 transitions to the operating state and/or that the test run is interrupted in case of a power failure and the fire protection system 3 transitions to the operational readiness state. In the case of a transition to the operating state, it is advantageous if the optical and acoustic alarming is configured in such a way that it outputs an indication indicating that the alarm presently being issued is no longer part of the test run, but that an actual fire has occurred. The meeting of this requirement for an indication may also be checked through the test method, for example.

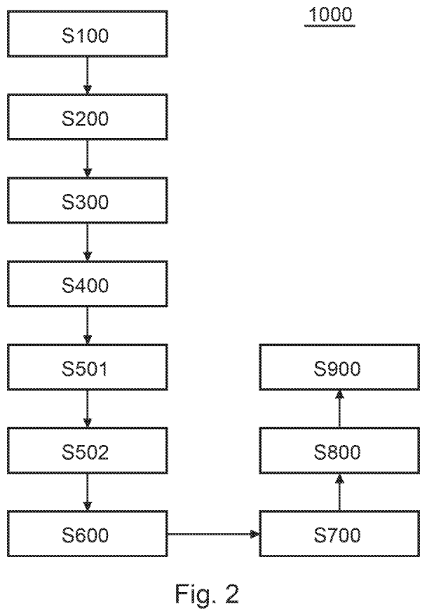

FIG. 2 schematically shows a flow chart of a test method 1000 according to the invention, which is carried out by the test system 1.

In step S100, the receiving device 11 of the test system 1 receives at least one test parameter from the system 2 for the automated monitoring of the protective readiness of a fire protection system 3. The receiving device 11 then passes the test parameter received in this manner to the processor unit 10 for evaluation of the test parameter.

In step S200 the processor unit 10 starts to evaluate the at least one test parameter. In the specific embodiment of FIG. 2, the evaluation in step S200 first comprises determining, by means of the processor unit 10, an identification of a component of the system 2 and comparing the identification with a corresponding list of approved components.

In step S300 the processor unit 10 further determines, based on a functional readiness indication comprised by the test parameter, whether, in the event of a fire, the system 2 is configured to change the fire protection system 3 within a period of less than 30 seconds from a testing state to an operating state and, based on the safety indication, whether the system 2 is configured to change the fire protection system 3 from a testing state to an operational readiness state in case of a loss of primary energy during a test run.

In step 400 the processor unit 10 further determines on the basis of the benchmark value indication that the storage heights of the materials within the fire protection area specified for the fire protection system 3 are below the specified limit values and that the extinguishing fluid supply by the fire protection system 3 within the fire protection area meets the necessary requirements.

In step S501 the processor unit 10 then identifies, on the basis of an evaluation result contained in the test parameter, the tested measurement parameters contained in the evaluation result. In step S502 the processor unit 10 compares the measurement parameters determined in this way with a specification which specifies which measurement parameters must be tested by the system 2 in order to be able to assume a functionality of the system 2 in conformity with the specification, and determines whether all measurement parameters to be tested according to the specification were actually tested by the system 2.

In step S600 the processor unit 10 concludes that the components used in the system 2 and identified by the identification comply with the specifications and generates a corresponding approval indication. In step S700 the processor unit 10 further concludes that—in case of a test run—the system 2 can guarantee both a changing to the operating state and to the operational readiness state and generates a corresponding certification indication.

In step S800 the evaluation of the processor unit 10 further shows that all measurement parameters which according to the specifications are to be tested by the system 2 have been tested by the system 2, i.e. that the system 2 is configured to test and evaluate all specified measurement parameters. The processor unit 10 then generates a corresponding completeness indication.

In step S900 the processor unit 10 then uses the results of the evaluation to generate a quality indication indicating the quality of the monitoring of the protection readiness by the system 2. If this quality indication indicates that the quality of monitoring is high, the system 2 is able to operate as configured.

If the displayed quality is below a predefined quality threshold, the test system 1 can output a notification to prompt a user to adjust the system 2 to improve the quality of the monitoring. In some embodiments this notification may be a notification to shorten the time intervals between test runs, for example.

In some embodiments the generation and output of the quality indication in step S900 further comprises an automatic reaction of the system to the quality value indicated by the quality indication falling below a quality threshold value. This means that in some embodiments the system may be configured to automatically make corresponding changes to improve the quality of the monitoring.

These changes may be specified by the test system as part of the quality indication or may be determined by the system 2 itself. Further embodiments are conceivable.

### LIST OF UTILIZED REFERENCE NUMBERS

Test system 1
Processor unit 10
Receiving device 11
Memory 12
Display unit 13
System for automated monitoring of protection readiness 2
Fire protection system 3
First sensor 31
Second sensor 32
Communication link 40
Peripheral device 50
High rack 60
Test method 1000
Receipt of the test parameter S100
Identification of a component S200
Evaluation of the functional readiness indication and safety indication S300
Evaluation of the benchmark value indication S400
Identification of the tested measurands S501
Comparison with the measurands to be tested S502
Approval of the component S600
Verification of the functional readiness indication and safety indication S700
Verification of the measurands S800
Generation of the quality indicator S900

1. Test method for testing a system for automated monitoring of a protection readiness of a fire protection system, comprising the following steps:
receiving at least one test parameter of the system,
evaluating the at least one test parameter on the basis of at least one specification for the at least one test parameter, and
determining, on the basis of the evaluating, a quality indicator which indicates the quality of the monitoring of the fire protection system by the system.

2. The test method according to claim 1,
wherein the at least one test parameter comprises a functional readiness indication, and
wherein the evaluating comprises determining, on the basis of the functional readiness indication, that the system is configured to change the fire protection system from a testing state to an operating state in the event of a fire.

3. The test method according to claim 2, further comprising determining, on the basis of the functional readiness indication, that the changing to the operating state takes place within a time span, which is less than a predetermined threshold value, after the fire event has been registered.

4. The test method according to claim 1,
wherein the at least one test parameter comprises a safety indication, and
wherein the evaluation comprises determining, on the basis of the safety indication, that the system is configured to change the fire protection system from a testing state to an operational readiness state in case of a power failure.

5. The test method according to claim 1,
wherein the at least one test parameter comprises a termination indication, and
wherein the evaluation comprises determining, on the basis of the termination indication, that the system is configured to change the fire protection system from a testing state to an operational readiness state in the event of a test failure.

6. The test method according to claim 1, wherein the at least one test parameter comprises an evaluation result of an evaluation of at least one measured value of at least one measurement parameter which indicates the protection readiness of the fire protection system, wherein the evaluating of the at least one test parameter further comprises:
determining all measurement parameters to be tested, and
comparing whether the at least one test parameter comprises at least one evaluation result for each measurement parameter to be tested.

7. The test method according to claim 1, further comprising:
providing a safeguarding of the at least one test parameter against modification by a user.

8. The test method according to claim 1, wherein the at least one test parameter comprises an identification of at least one component of a system for automated monitoring of the fire protection system, wherein the evaluating further comprises:
verifying an approval of the at least one component of a system for automated monitoring of the fire protection system on the basis of the identification.

9. The test method according to claim 1, further comprising:
testing of at least one test history, wherein the test history indicates the progression of the test parameter over time.

10. The test method according to claim 1, further comprising:
determining a time interval for the monitoring of the protection readiness of the fire protection system by the system on the basis of the quality indicator.

11. A computer program with program code which cause a processor unit to carry out the method according to claim 1.

12. A test system for testing a system for automated monitoring of a protection readiness of a fire protection system, comprising:
a receiving device configured to receive at least one test parameter of the system via a communication link, and
a processor unit which is configured
to evaluate the at least one test parameter on the basis of at least one specification for the at least one test parameter, and
to determine, on the basis of the evaluating, a quality indicator indicating the quality of the monitoring of the fire protection system by the system.

13. The test system according to claim 12, wherein the at least one test parameter comprises:
a functional readiness indication indicating a configuration of the system to change the fire protection system from a testing state to an operating state in the event of a fire; and/or
a safety indication indicating a configuration of the system to change the fire protection system from a testing state to an operational readiness state in case of a power failure.

14. The test system according to claim 12, wherein the communication link comprises a secured connection.

15. The test system according to claim 12, wherein the communication link comprises a wireless communication link.
